(19) United States
(12) Patent Application Publication
(10) Pub. No.: US 2021/0247803 A1
(43) Pub. Date: Aug. 12, 2021

(54) Method for folding flexible screen of electronic device

(71) Applicant: Yongbiao Liu, Salinas, CA (US)

(72) Inventor: Yongbiao Liu, Salinas, CA (US)

(21) Appl. No.: 16/785,568

(22) Filed: Feb. 8, 2020

(51) Int. Cl. G06F 1/16

(52) U.S. Cl. CPC G06F 1/1616; G06F 1/1652

(57) ABSTRACT

A method for folding flexible screen of electronic device comprises; a U-shaped channel element with a bottom and two side walls serving as the spine of a folding electronic device with a front body and a back body and the front and back bodies are flexibly connected to the side walls of the channel element. The inner surfaces of the front and back bodies each comprises a swing panel on the side of the channel element and the swing panels are connected to the rests of the inner surfaces with flexible joints. When the device is at a fully open position, the swing panels of the front and back bodies are positioned on tops of the side walls of the channel element and are aligned next to each other along the center axis line of the channel element. A flexible screen covers across the inner surfaces of the front and back bodies. As the front and back bodies fold, the swing, panels swing to maintain a constant contact with the side walls of the channel element and separate in the channel element. The separation of the swing panels in the channel element create a space for the flexible screen to have a curved folding without creating a crease to the flexible screen.

### BACKGROUND OF THE INVENTION

### 1. Field of the Invention

The present invention relates to personal electronic devices; and more particularly the present invention relates to smartphones, notepad computers, notebook computers, electronic game terminals, and others with folding flexible screens.

### 2. Description of the Related Art

It is desirable for electronic devices such as srnartphones, notepad computers, and notebook computers to have fold screens to reduce format sizes for easy carry and transport but retain larger screens for comfortable viewing. To achieve these purposes, various folding phones and other folding electronic devices have been devised using, flexible screens and various methods to fold flexible screens. But all prior arts differ from the present invention in a variety of ways.

### SUMMARY OF THE INVENTION

As flexible screen materials become widely available, it is become possible to have smartphones and other electronic devices with folding screens to be able to have large screens for better viewing experience but still maintain relatively smaller sizes to carry in pockets/bags and held in hands. The primary objective of the current invention is to provide a method for folding flexible screens that can used to create smartphones, notepad computers, notebook computers, and other electronic devices with folding flexible screens. It is another objective to provide a method for folding flexible screens that is simple for easy adaptation on electronic devices.

To achieve these objectives, the method of the current invention comprises a U-shaped channel element with two side walls and a bottom serving as the spine of a folding electronic device with a front body and a back body and the front and back bodies are flexibly connected to the walls of the channel element, the inner surfaces of the front and back bodies each comprises a swing panel close to the channel element and the swing panel is flexibly connected to the rest parts of the inner surfaces. When the device is at a fully open position, the swing panels of the front and back bodies are positioned on tops of the side walls of the channel element and are near each other along the center axis of the channel element. The swing panels together with the rest, of inner surfaces of the front and back bodies form a flat surface to support a flexible screen covering across the inner surfaces including the swing panels of the front and back bodies. The flexible screen is permanently attached to most parts of the inner surfaces of the front and back bodies except a strip of each swing panel on the side of the channel element. When the front and back bodies fold, the swing, panels swing, down, separate, and maintain contact with the walls of the channel element as forced by the expanding force of the folding screen as the flexible screen is being folded. The separation of the swing panels in the channel element create a space for the flexible screen to have a curved folding without creating a crease to the flexible screen.

The invention further comprises a plurality of mechanisms to keep the swing panels in contact with the side walls of the channel element. The plurality of mechanisms includes flexible connections between the swing panels and the rests of the inner surfaces of the front and back bodies of the electronic device that have resilient downward bending pressures on the swing panels and, thereby, keep the swing panels in constant contact with the side walls of the channel element. The plurality of mechanisms may also include the swing panels made of ferrous metal and the side walls of the channel element with magnetic property and the attraction force between the swing panels and the side walls of the channel element keeps the swing panels in constant contact with the side walls of the channel element.

The present invention has advantages of allowing curved folding of flexible screen and prevent causing, a crease to the flexible screen when the electronic device is folded, and, thereby, makes it possible to have a large flexible folding screen on an electronic device. The described features and specifications may be combined in any suitable manner in one or more embodiments. One skilled in the relevant art will recognize that the invention can be practiced without one or more of the specific features or advantages of an embodiment.

### Definitions

Front body: the left part or top part of a folding electronic device such as a smartphone when it is unfolded. Back body: the right part or bottom part of a folding electronic devise such as a smartphone when it is unfolded. Outer cover: the cover or shell exposed to outside when the phone is folded. Inner surface: the surface which is sealed in the middle when a folding electronic device is at a folded state and is exposed when the device is open.

### BRIEF DESCRIPTION OF THE DRAWINGS

FIG. 1 is a perspective view of a preferred embodiment of the present invention.

FIG. 2 is a schematic perspective view of the preferred embodiment of the present invention at a fully open position without a flexible screen, to show structures and the mechanism of folding a flexible screen.

FIG. 3 is a perspective dissection view of the preferred embodiment at a partially folded position to show the channel element, swing panels, and folding mechanism of a flexible screen.

FIG. 4 is a schematic side view of cross section of the preferred embodiment of the present invention showing the mechanism of keeping a flat surface of the inner surfaces and the swing panels underneath the flexible screen and curved folding of the flexible screen.

### DETAILED DESCRIPTION

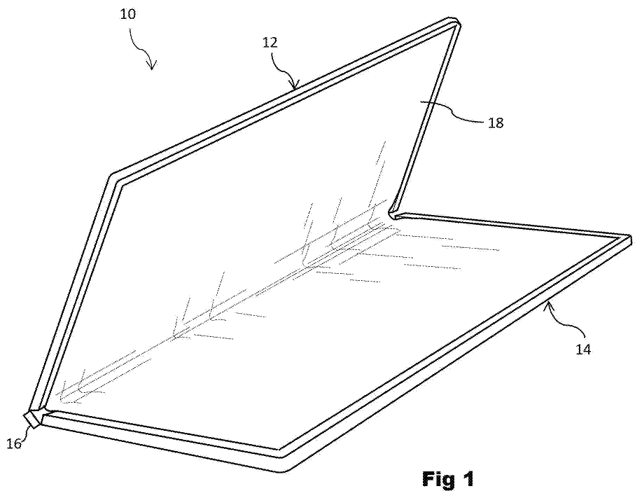

With reference to FIG. 1 for a perspective view 10 of a preferred embodiment of the current invention with flexible folding screen comprises a front body 12, a back body 14, a channel element 16 serving as a spine for the front and back bodies 12, 14, and, a flexible inner screen 18 covering the inner surfaces of the front body and back bodies 12, 14.

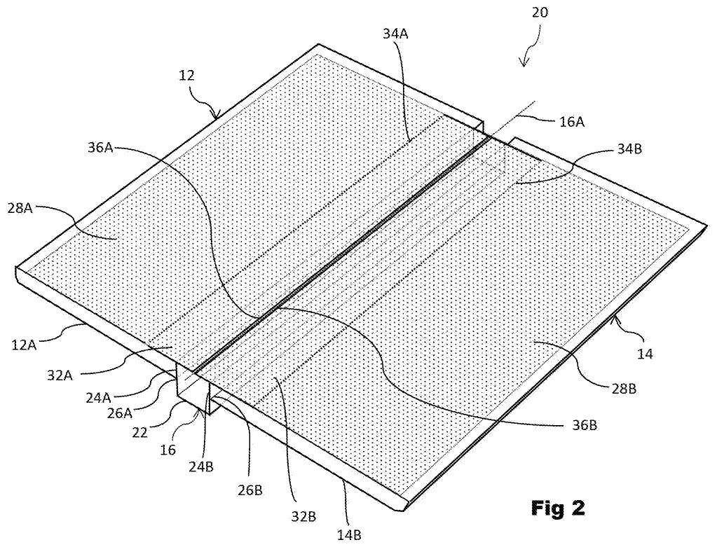

With reference to FIG. 2, a perspective dissection top view 20 of the preferred embodiment at a fully open position shows that the front body 12 and the back body 14 have two swing panels 32A, 32B connected by flexible joints 34A, 348 with the inner surface areas 28A, 288 of the front and back bodies 12, 14. A channel element 16 has a bottom 22 and two side walls 24A, 24B. The outer covers 12A, 14B of the front and back bodies 12, 14 are connected to the side walls 24A, 248 of the channel element 16 with flexible joints 26A, 26B. The two swing panels 32A, 32B have their edges 36A, 36B positioned near each other along the central axis line 16A of the channel element 16. In a fully open position, the swing panels 32A, 328 supported by the side walls 24A, 24B of the channel element 16 form a flat surface together with the rest of inner surfaces 28A, 28B of the front and back bodies 12, 14 to support a flexible screen on top.

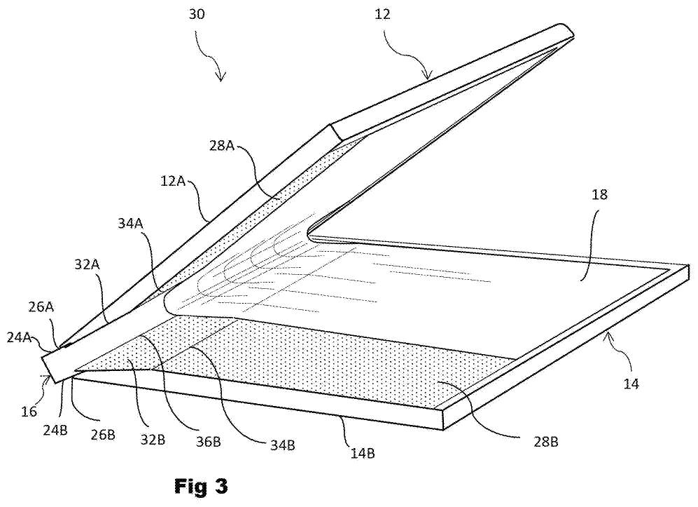

With reference to FIG. 3, a perspective view 30 of a horizontal dissection of the preferred embodiment of the current invention shows the flexible screen 18 is attached to inner surface areas 28A, 28B and parts of the swing panels 32A, 328 of the front body and back bodies 12, 14 respectively. The outer covers 12A, 14B of the front and back bodies 12, 14 are connected to the side walls 24A, 248 of the channel element 16 with flexible joints 26A, 26B. The embodiment 30 is at a partially folded state with the flexible screen 18 folded. Two swing panels 32A, 32B are connected to the inner surface areas 28A, 288 with flexibly joints 34A, 348 respectively. As the device folds, the swing panels 32A, 32B swing apart to form a space to allow the flexible screen 18 to have a curved folding.

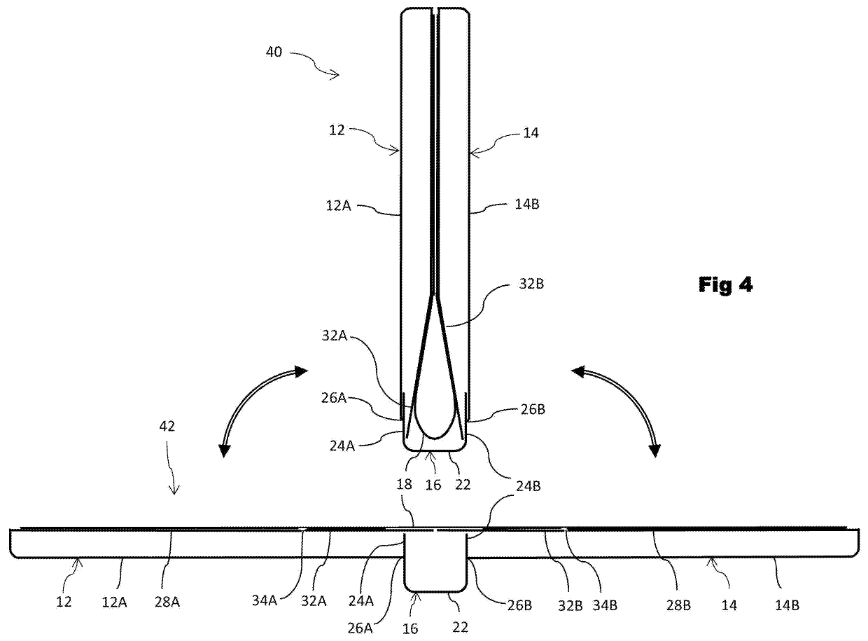

FIG. 4 shows two horizontal dissection side schematic views 40, 42 of the preferred embodiment of the current invention at fully folded and fully open sates, respectively. When the device is at fully fold position 40, the swing panels 32A, 32B are pressed in contact with the side walls 24A, 24B of the channel element 16. The flexible screen 18 has a curved folding in the space created by the swing panels 32A, 32B. As the device opens to a fully open position 42, the front and back bodies 12, 14 open around two pivotal flexible joints 26A, 26B at or close to the middles of the side walls 24A, 248 of the channel element 16. The swing panels 32A, 328 together with inner surface areas 28A, 28B form a flat backing surface for the flexible screen 18. The flexible screen 18 is permanently affixed to the inner surface areas 28A, 288 and parts of the swing panels 32A, 328 next to the flexible joints 34A, 34B. The flexible screen 18 is separable from parts of the swing panels 32A, 32B next to the center of the cannel element 16. The current invention may also comprise several optional mechanisms for maintain a constant contact between the swing panels 32A, 32B and the side walls 24A, 24B of the channel element 16. One of the said mechanisms may include the flexible joints 34A, 348 with a resilient downward bending pressure and the said pressure keeps the swing panels 32A, 328 in constant contact with the side walls 24A, 248 of the channel element 16. Another of the said mechanisms may include the swing panels 32A, 328 made of ferrous metal and the side walls 24A, 248 with magnetic property and the magnetic attraction force between the swing panels 32A, 328 and the side walls 24A, 248 keeps the swing panels 32A, 328 in constant contact with the side walls 24A, 248 of the channel element 16. The bending of the flexible screen 18 also exerts pressure to separate the swing panels 32A, 32B in the channel element 16. The separation of the swing panels 32A, 32B in the channel element 16 creates a space for the flexible screen 18 to have a curved folding without creating a crease to the flexible screen 18.

1. A method for folding flexible screen of electronic device comprises; a channel element with a bottom and two side walls serving as the spine of a folding electronic device with a front body and a back body, and the front and back bodies are flexibly connected to the side walls of the channel element, the inner surfaces of the front and back bodies each comprises a swing panel on the side of the channel element, and the swing panels are flexibly connected to the main parts of the inner surfaces of the front and back bodies; furthermore when the device is at an open position, the swing panels of the front and back bodies rest on tops of the side walls of the channel element and position next to each other along the center axis of the channel element; furthermore a flexible screen covers across the inner surfaces of the front and back bodies; furthermore as the front and back bodies fold, the swing panels separate in the channel element to create a space for the flexible screen to have a curved folding.

2. The method for folding flexible screen of electronic device as in the claim 1 whereas the channel element has side walls that have a height the same as or larger than the width of the channel element and the outer covers of the front and back bodies are flexibly connected to the walls of the channel at about or close to the middle of the side walls of the channel element.

3. The method for folding flexible screen of electronic device as in the claim 1 whereas the flexible screen is permanently attached to the inner surfaces of the front and back bodies and parts of the swing panels next to the flexible joints between the swing panels and the rest of inner surfaces.

4. The method for folding flexible screen of electronic device as in the claim 1 further comprises a plurality of means to pressure the swing panels in constant contact with the side walls of the channel element.

5. The plurality of means to pressure the swing panels in constant contact with the side walls of the channel element as in the claim 4 includes a property of resilient downward bending pressure of the flexible joints between the said swing panels and the rest of the inner surfaces of the said front and back bodies, and the pressure of the flexible joints presses the swing panels in constant contact with the side walls of the channel element.

6. The plurality of means to pressure the swing panels in constant contact with the side walls of the channel element as in the claim 4 includes that the swing panels being made of ferrous metals and the side walls of the channel element having magnetic property and the magnetic attraction force between the swing panels and the side walls of the channel element keeps the swing panels in constant contact with the side walls of the channel element.

7. A method for folding flexible screen of electronic device comprises: a U-shaped channel element with two side walls and bottom serving as the spine of a folding electronic device with a front body and a back body, and the front and back bodies are flexibly connected to the side walls of the channel element, the inner surfaces of the front and back bodies each comprises a swing panel on the side of the channel element and the swing panels are flexibly connected to the rest parts of the inner surfaces; furthermore when the device is at a fully open position, the swing panels of the front and back bodies rest over the walls of the channel element and in close proximity along, the center axis of the channel element; furthermore a flexible screen covers across the inner surfaces of the front and back bodies and permanently attached to the backing surfaces of the front and back bodies and to a part of the swing panels on the far sides from the channel element; furthermore as the front and back bodies fold, the swing panels are pressed in contact the walls of the channel element and a separation of the swing panels in the channel element create a space for the flexible screen to have a curved folding without creating a crease to the flexible screen.
